(19) United States
(12) Patent Application Publication
(10) Pub. No.: US 2009/0060682 A1
(43) Pub. Date: Mar. 5, 2009

(54) SCREW ASSEMBLY WITH VIBRATION-ABSORBING MEMBER

(75) Inventors: CHIN-WEN YEH, Tu-Cheng (TW); ZHEN-NENG LIN, Shenzhen (CN)

Correspondence Address: PCE INDUSTRY, INC.;ATT. CHENG-JU CHIANG, 458 E. LAMBERT ROAD, FULLERTON, CA, 92835, US

(73) Assignees: HONG FU JIN PRECISION INDUSTRY (ShenZhen) CO. LTD, Shenzhen City (CN); HON HAI PRECISION INDUSTRY CO., LTD., Tu-Cheng (TW)

(21) Appl. No.: 11/923,669

(22) Filed: Oct. 25, 2007

(30) Foreign Application Priority Data
Aug. 29, 2007 (CN) 200720200898.2

(51) Int. Cl. F16B 43/00

(52) U.S. Cl. 411/533

(57) ABSTRACT

A screw assembly includes a screw (10), a positioning member (30), a vibration-absorbing member (40), and a shielding member (20). The screw includes a head portion (12), a threaded portion (16) and a neck portion (14) connecting the head portion and the threaded portion. The positioning member is secured on the neck portion of the screw adjacent the head portion. The vibration-absorbing member surrounds the threaded portion and the neck portion of the screw. The shielding member includes a top portion (22) and a shielding portion (24) extending from the top portion. The top portion is positioned on the screw between the head portion and the positioning member. The shielding portion encloses the positioning member and the vibration-absorbing member.

### BACKGROUND

1. Technical Field

The present invention relates to screw assemblies, and more particularly to a screw assembly with a vibration-absorbing member.

2. General Background

A screw is usually provided to secure a device, such as a disk drive, in a bracket. However, vibration is often generated by the device when it is operating. If the vibration cannot be isolated from the device, the device may be damaged.

Accordingly, a vibration-absorbing member is further provided. The vibration-absorbing member is secured on the screw, and abuts on the device when the screw is mounted on the device. In assembling the device in the bracket, the screw is installed in a slideway defined in the bracket, and the vibration-absorbing member touches on the slideway. However, the vibration-absorbing member easily wears out over time because of friction between the vibration-absorbing member and the slideway of the bracket when the device together with the screw slides along the slideway of the bracket.

What is needed, therefore, is a screw assembly with a durable vibration-absorbing member.

### SUMMARY

A screw assembly includes a screw, a positioning member, a vibration-absorbing member, and a shielding member. The screw includes a head portion, a threaded portion, and a neck portion connecting the head portion and the threaded portion. The positioning member is secured on the neck portion of the screw adjacent the head portion. The vibration-absorbing member surrounds the threaded portion and the neck portion of the screw. The shielding member includes a top portion and a shielding portion extending from the top portion. The top portion is positioned on the screw between the head portion and the positioning member. The shielding portion encloses the positioning member and the vibration-absorbing member.

Other advantages and novel features will be drawn from the following detailed description of embodiments with attached drawings, in which:

### BRIEF DESCRIPTION OF THE DRAWINGS

FIG. 1 is an exploded, isometric view of a screw assembly of a preferred embodiment of the present invention, the screw assembly including a screw, a shielding member, a positioning member, and a vibration-absorbing member;

FIG. 2 is another exploded, isometric view of the screw assembly of FIG. 1;

FIG. 3 is an assembled, cutaway view of the screw assembly of FIG. 1; and

FIG. 4 is a cutaway view of the screw assembly together with a bracket and a device.

### DETAILED DESCRIPTION

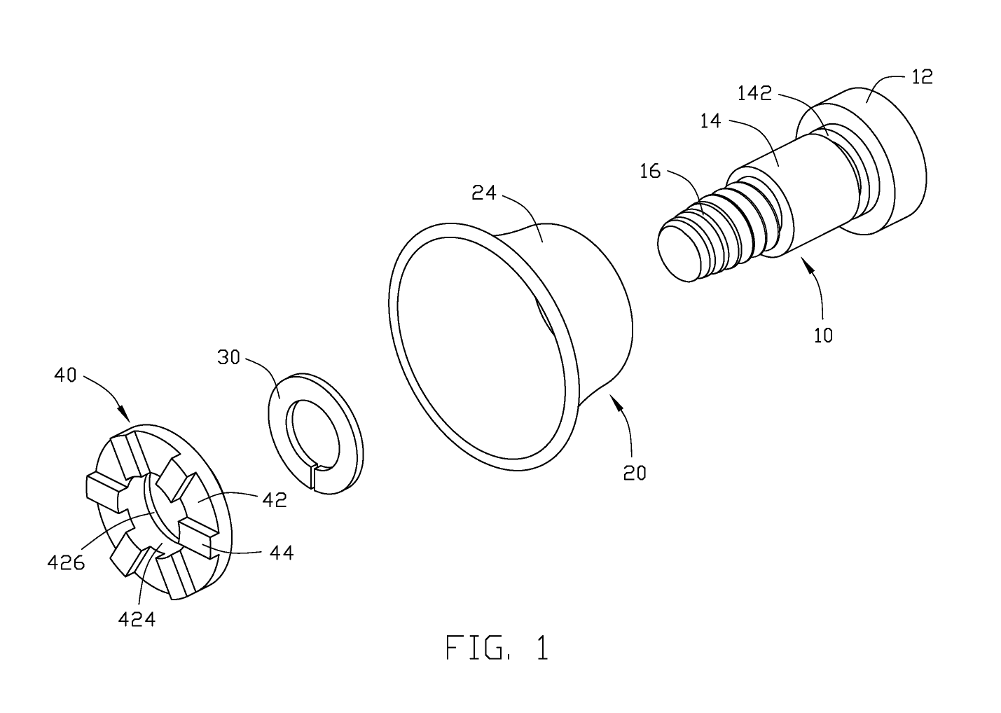

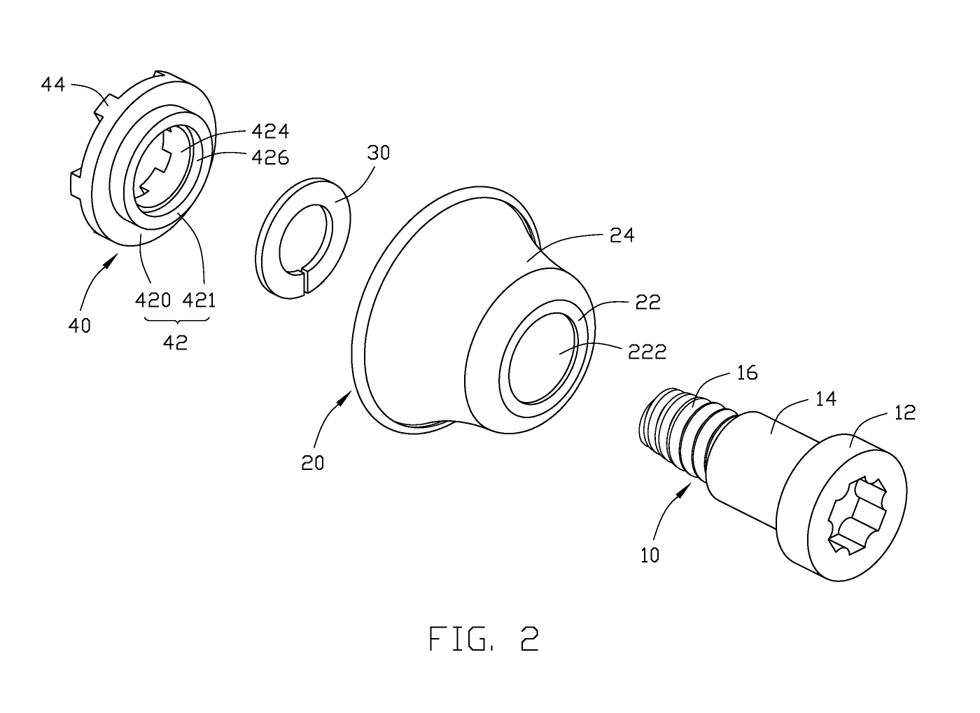

Referring to FIGS. 1-2, a screw assembly of an embodiment of the present invention includes a screw 10, a shielding member 20, a positioning member 30, and a vibration-absorbing member 40.

The screw 10 includes a head portion 12, a neck portion 14, and a threaded portion 16. The neck portion 14 connects the head portion 12 and the threaded portion 16. A diameter of the neck portion 14 is less than that of the head portion 12, but greater than that of the threaded portion 16. A circular slot 142 is defined in the neck portion 14, adjacent the head portion 12.

The shielding member 20 is generally bell-shaped, and includes a top portion 22 and a shielding portion 24 bent from a circular edge of the top portion 22. The top portion 22 defines a circular through hole 222 in the middle thereof. The diameter of the through hole 222 is greater than that of the neck portion 14 of the screw 10, but less than that of the head portion 12 of the screw 10.

In this embodiment, a split washer is used as the positioning member 30 to allow resilient expansion and/or contraction of the positioning member 30. The inside diameter of the positioning member 30 is less than the diameter of the neck portion 14 of the screw 10, but greater than the inside diameter of the slot 142 of the neck portion 14. The outside diameter of the positioning member 30 is greater than the diameter of the neck portion 14 of the screw 10, and a little greater than the diameter of the through hole 222 of the shielding member 20.

The vibration-absorbing member 40 includes a base portion 42 and a plurality of ribs 44 formed on the base portion 42. The base portion 42 also includes a first cylindrical portion 420, and a second cylindrical portion 421 connected to the first cylindrical portion 420. The diameter of the first cylindrical portion 420 is greater than that of the second cylindrical portion 421. The base portion 42 defines a first circular through hole 424 in the first and second cylindrical portions 420, 421, and a coaxial second circular through hole 426 in the second cylindrical portion 421 communicating with the first through hole 424. The diameter of the first through hole 424 is less than that of the second through hole 426, but less than that of the neck portion 14 of the screw 10. The diameter of the second through hole 426 is slightly greater than that of the threaded portion 16 of the screw 10. The ribs 44 are symmetrically arranged on an end surface of the first cylindrical portion 420 around an axis of the first and second through holes 424, 426.

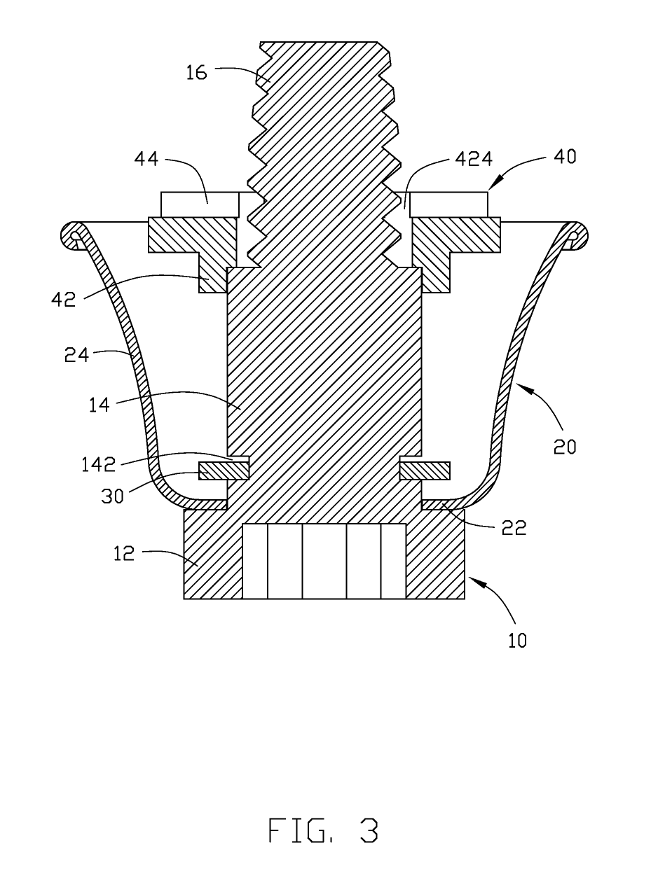

Referring also to FIG. 3, in assembly, the threaded portion 16 and the neck portion 14 of the screw 10 are inserted through the through hole 222 of the top portion 22 and the shielding portion in turn from outside of the shielding member 20, and the threaded portion 16 of the screw 10 is exposed outside of the shielding member 20. When the top portion 22 of the shielding member 20 abuts on the head portion 12 of the screw 10, the top portion 22 is positioned between the slot 142 of the neck portion 14 and the head portion 12 of the screw 10. The positioning member 30 is resiliently expanded so as to surround and move along from the threaded portion 16 to the neck portion 14 of the screw 10. When the positioning member 30 aligns with the slot 142 of the neck portion 14, the positioning member 30 contracts and thereby engages in the slot 142. At this time, because the inner diameter of the positioning member 30 is less than the neck portion 14, and the outer diameter of the positioning member 30 is greater than that of the neck portion 14 and the through hole 222 of the top portion 22 of the shielding member 20, the positioning member 30 retains the shielding member 30 between the head portion 12 of the screw 10 and the positioning member 30. The vibration-absorbing member 40 is installed on the screw 10, and surrounds the threaded portion 16 and the neck portion 14 thereof. Because the diameter of the first through hole 424 is greater than that of the threaded portion 16 of the screw, but less than that of the neck portion 14, and the diameter of the second through hole 426 is equal to that of the neck portion 14, the first through hole 424 receives the threaded portion 16 and the second through hole 426 receives a portion of the neck portion 14 adjacent the threaded portion 16.

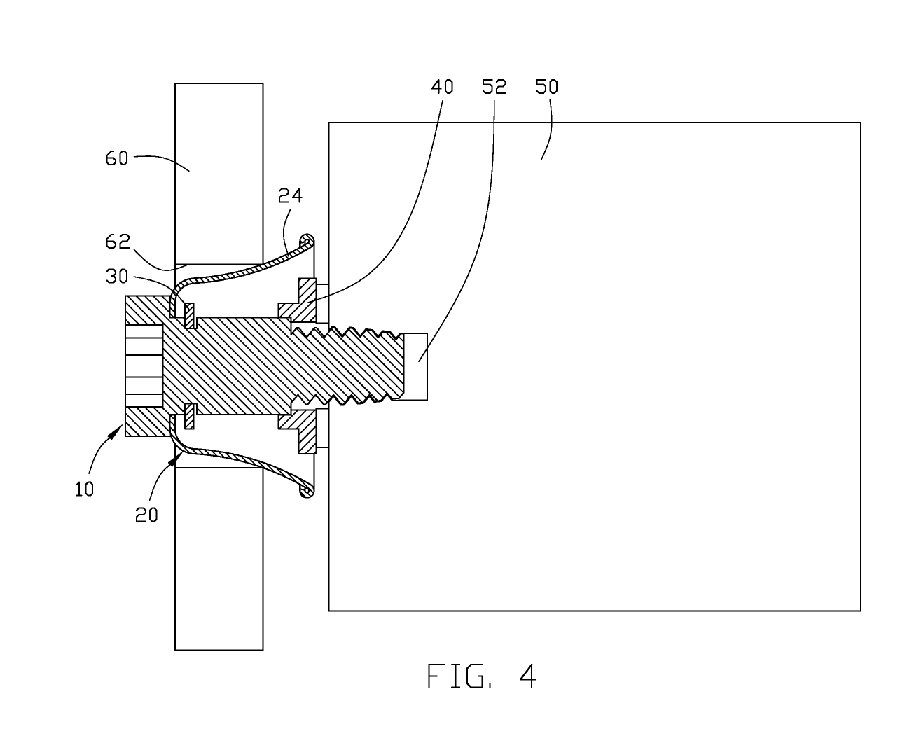

Referring also to FIG. 4, in use, a plurality of the screw assemblies can be used to secure a device 50 in a bracket 60. Only one of the screw assemblies is shown in FIG. 4. The threaded portion 16 of the screw 10 is screwed into a mounting hole 52 defined in the device 50 until the ribs 44 of the vibration-absorbing member 40 abut on the device 50. The device 50 is then installed in the bracket 60 by the screw assembly being inserted in a slot 62 defined in the bracket 60. In the present embodiment, the bracket 60 includes a vertically oriented plate with the slot 62 defined therein, the screw 10 is horizontally oriented and is engaged between the plate and the device 50.

The vibration-absorbing member 40 of the screw assembly is capable of absorbing or dampening vibrations generated by the device 50 and the bracket 60, thereby protecting the device 50 from damage. Because the shielding member 20 keeps the vibration-absorbing member 40 from touching the bracket 60, no friction exists between the vibration-absorbing member 40 and the bracket 60, and life of the vibration-absorbing member 40 is thereby prolonged.

In this embodiment, the shielding member 20 can also be a cylinder. The positioning member 30 can also be a flat washer, or some other washer members that can prevent the shielding member 20 being disengaged from the screw 10.

It is to be understood, however, that even though numerous characteristics and advantages have been set forth in the foregoing description of preferred embodiments, together with details of the structures and functions of the preferred embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A screw assembly comprising:
a screw comprising a head portion, a threaded portion and a neck portion connecting the head portion and the threaded portion;
a positioning member secured on the neck portion of the screw adjacent the head portion;
a vibration-absorbing member surrounding the threaded portion and the neck portion of the screw; and
a shielding member comprising a top portion and a shielding portion extending from the top portion, the top portion being positioned on the screw between the head portion and the positioning member, the shielding portion enclosing the positioning member and the vibration-absorbing member.

2. The screw assembly as described in claim 1, wherein the neck portion of the screw defines a circular slot therein for receiving the positioning member therein.

3. The screw assembly as described in claim 2, wherein the outside diameter of the positioning member is greater than the diameter of the neck portion of the screw, and the inside diameter of the positioning member is greater than the inside diameter of the circular slot, but less than that of the neck portion.

4. The screw assembly as described in claim 3, wherein the top portion of the shielding member defines a circular through hole therein, and the diameter of the through hole is less than that of the head portion of the screw and the outer diameter of the positioning member, and greater than that of the neck portion of the screw.

5. The screw assembly as described in claim 1, wherein the positioning member is a split washer for facilitating the positioning member resiliently expanding and contracting.

6. The screw assembly as described in claim 1, wherein the vibration-absorbing member comprises a base portion defining a first circular through hole and a second circular through hole communicating with the first through hole, the diameter of the first through hole less than that of the neck portion of the screw, but greater than that of the threaded portion.

7. The screw assembly as described in claim 6, wherein the vibration-absorbing member further comprises a plurality of ribs symmetrically arranged on the base portion around an axis of the first and second through hole thereof, and exposed outside the shielding portion of the shielding member.

8. The screw assembly as described in claim 1, wherein the diameter of the neck portion of the screw is less than that of the head portion of the screw, but greater than that of the threaded portion of the screw.

9. The screw assembly as described in claim 1, wherein the shielding member is generally bell-shaped.

10. A screw assembly comprising:
a screw;
a shielding member comprising a top portion and a shielding portion extending from a circular edge of the top portion, the top portion defining a through hole therein for receiving the screw, the shielding portion defining an exit therein;
a positioning member removably attached to the screw for preventing the top portion of the shielding member removing from the screw, and positioned in the shielding portion of the shielding member; and
a vibration-absorbing member secured on the screw, and positioned in the exit of the shielding portion of the shielding member for shielding the positioning member in the shielding member.

11. The screw assembly as described in claim 10, wherein the screw comprises a head portion, a threaded portion, and a neck portion communicating with the head portion and the threaded portion, the diameter of the neck portion being less than that of the head portion, but greater that of the threaded portion.

12. The screw assembly as described in claim 11, wherein the neck portion of the screw defines a circular slot therein for receiving the positioning member therein.

13. The screw assembly as described in claim 12, wherein the outside diameter of the positioning member is greater than the diameter of the neck portion of the screw, and the inside diameter of the positioning member is greater than the inside diameter of the circular slot, but less than the diameter of the neck portion.

14. The screw assembly as described in claim 13, wherein the diameter of the through hole is less than that of the head portion of the screw and the outside diameter of the positioning member, and greater than that of the neck portion of the screw.

15. The screw assembly as described in claim 10, wherein the positioning member is a split washer for facilitating the positioning member resiliently expanding and contracting.

16. The screw assembly as described in claim 10, wherein the vibration-absorbing member comprises a base portion defining a first circular through hole and a second circular through hole communicating with the first through hole, the diameter of the first through hole is less than that of the neck portion of the screw, but greater than that of the threaded portion, the diameter of the second through hole is greater than that of the neck portion of the screw.

17. The screw assembly as described in claim 16, wherein the vibration-absorbing member further comprises a plurality of ribs symmetrically arranged on the base portion around an axis of the first and second through hole thereof, and exposed outside the shielding portion of the shielding member.

18. An assembly comprising:
a vertically oriented panel defining an through opening therein;
a device having a side surface facing the panel and a threaded hole defined in the side surface;
a horizontally oriented screw comprising a head portion, a threaded portion and a neck portion interconnected between the head portion and the threaded portion, the threaded portion being in threaded engagement in the threaded hole of the device;
a positioning member secured on the neck portion of the screw adjacent the head portion;
a vibration-absorbing member surrounding the threaded portion and the neck portion of the screw and abutting against the side surface of the device; and
a shielding member comprising a top portion and a shielding portion extending from the top portion, the top portion being positioned on the screw between the head portion and the positioning member, the shielding portion enclosing the positioning member and the vibration-absorbing member, and being engaged in the through opening of the panel.

19. The assembly as described in claim 18, wherein the neck portion of the screw defines a slot therein for receiving the positioning member therein, so as to secure the positioning member on the neck portion of the screw.

20. The assembly as described in claim 19, wherein the outside diameter of the positioning member is greater than the diameter of the neck portion of the screw, and the inside diameter of the positioning member is greater than the inside diameter of the circular slot, but less than the diameter of the neck portion.
